(19) United States
(12) Patent Application Publication
(10) Pub. No.: US 2025/0033734 A1
(43) Pub. Date: Jan. 30, 2025

(54) FRONT FORK

(71) Applicant: KYB Motorcycle Suspension Co.,Ltd., Gifu (JP)

(72) Inventor: Kimiaki MAKINO, Gifu (JP)

(73) Assignee: KYB Motorcycle Suspension Co.,Ltd., Gifu (JP)

(21) Appl. No.: 18/760,056

(22) Filed: Jul. 1, 2024

(30) Foreign Application Priority Data
Jul. 26, 2023 (JP) 2023-121397

(51) Int. Cl. B62K 25/08

(52) U.S. Cl. CPC B62K 25/08

(57) ABSTRACT

A front fork includes: an upper tube; a lower tube that is relatively movable in an axial direction with respect to the upper tube; and an axle bracket screwed to an outer periphery of a lower end portion of the lower tube, in which the lower tube has a screw thread formed on an outer periphery of a diameter-reduced portion that is reduced in diameter by plastic deformation by rolling at the lower end portion of the lower tube and the axle bracket is screwed to the screw thread.

### BACKGROUND

### Technical Field

The present invention relates to a front fork.

### Related Art

A front fork is used for a straddle vehicle, supports a steering wheel on a front side of the straddle vehicle, and exerts a damping force during expansion and contraction to suppress vibration of a vehicle body. Such a front fork includes an upper tube, a lower tube movably inserted into the upper tube, an axle bracket that closes a lower end of the lower tube and holds an axle of the steering wheel, and a shock absorber attached between the upper tube and the lower tube and generates a damping force when expanding and contracting.

Since the front fork is filled with hydraulic oil for exerting a damping force, it is necessary to seal a space between the lower tube and the axle bracket. For example, as disclosed in JP 2016-70313 A, the axle bracket has a bottomed cylindrical shape including a cylindrical portion screwed to a screw portion provided on an outer periphery of the lower end of the lower tube and includes an annular groove that accommodates an O-ring on an inner periphery of the cylindrical portion. The O-ring accommodated in the annular groove of the axle bracket is in close contact with an outer periphery of a lowermost end of the lower tube at a position avoiding the screw portion to seal between the axle bracket and the lower tube and seal the inside of the front fork in an oil-tight manner (for example, see Patent Literature 1).

### SUMMARY

In the front fork configured as described above, since it is necessary to form the screw portion on the outer periphery of the lower end of the lower tube as described above, a thickness of the screw portion at the lower end of the lower tube is thinner than a thickness of a portion above the screw portion. On the other hand, there is a demand for weight reduction with respect to the front fork due to the demand for weight reduction of the vehicle weight of the straddle vehicle, and in order to meet the demand, in recent years, thickness reduction is promoted while increasing the diameters of the lower tube and the upper tube to increase the cross-sectional secondary moment. However, when the thickness of the screw portion of the lower tube is reduced, the strength is insufficient. Therefore, in the conventional front fork, there is a limit to the thickness reduction of the lower tube, making weight reduction difficult.

Therefore, an object of the present invention is to provide a front fork that can achieve weight reduction while securing the strength.

In order to achieve the above object, a front fork in the means for solving the problem of the present invention includes: an upper tube; a lower tube that is relatively movable in an axial direction with respect to the upper tube; and an axle bracket screwed to an outer periphery of a lower end portion of the lower tube, in which the lower tube has a screw thread formed on an outer periphery of a diameter-reduced portion that is reduced in diameter by plastic deformation by rolling at the lower end portion of the lower tube, and the axle bracket is screwed to the screw thread.

According to the front fork configured as described above, since a thickness of the diameter-reduced portion in which the screw thread of the lower tube is reduced in diameter by plastic deformation is substantially the same as a thickness of a portion above the diameter-reduced portion of the lower tube, and the screw thread is formed by plastic deformation in which the screw thread rises from the diameter-reduced portion by rolling, a thickness from an outer periphery of the screw thread to an inner periphery of the diameter-reduced portion can be made thicker as compared with a case where the screw thread is formed by cutting in which the thickness decreases, and the strength of a screw thread portion can be secured.

A front fork in another means for solving the problem of the present invention includes: an upper tube; a lower tube that is relatively movable in an axial direction with respect to the upper tube; and an axle bracket screwed to an outer periphery of a lower end portion of the lower tube, in which the lower tube has a diameter-reduced portion of which an inner diameter is reduced from an upper side at a lower end portion, and a screw thread provided on an outer periphery of the diameter-reduced portion and to which the axle bracket is screwed, and a radial thickness from an inner periphery of the diameter-reduced portion to an outer periphery of the screw thread is thicker than a radial thickness of a portion above the diameter-reduced portion of the lower tube. According to the front fork configured as described above, a thickness of an upper side of the lower tube can be made thin while securing a thickness of a screw thread portion, and weight reduction of the lower tube becomes possible.

Further, a method for manufacturing a front fork in the means for solving the problem of the present invention is a method for manufacturing a front fork including: an upper tube; a lower tube that is relatively movable in an axial direction with respect to the upper tube; and an axle bracket screwed to an outer periphery of a lower end portion of the lower tube, the method including: a diameter reduction step of reducing a diameter of the lower end portion of the lower tube by plastic deformation to form a diameter-reduced portion; and a screw forming step of forming a screw thread on an outer periphery of the diameter-reduced portion by rolling.

According to the method for manufacturing the front fork configured as described above, since a thickness of the diameter-reduced portion in which the screw thread of the lower tube is reduced in diameter by plastic deformation is substantially the same as a thickness of a portion above the diameter-reduced portion of the lower tube, and the screw thread is formed by plastic deformation in which the screw thread rises from the diameter-reduced portion by rolling, a thickness from an outer periphery of the screw thread to an inner periphery of the diameter-reduced portion can be made thicker as compared with a case where the screw thread is formed by cutting in which the thickness decreases, and the strength of a screw thread portion can be secured.

### BRIEF DESCRIPTION OF DRAWINGS

FIG. 1 is a sectional view of a front fork according to an embodiment of the present invention;

FIG. 2 is a partially enlarged sectional view of the front fork according to the embodiment of the present invention;

FIG. 3 is an enlarged sectional view of a modification of the front fork according to the embodiment of the present invention;

FIG. 4 is a view for explaining a diameter reduction step of swaging a pipe to form a diameter-reduced portion in a pipe; and

FIG. 5 is a view for explaining a screw thread forming step of forming a screw thread by rolling on a diameter-reduced portion formed in the pipe.

### DETAILED DESCRIPTION

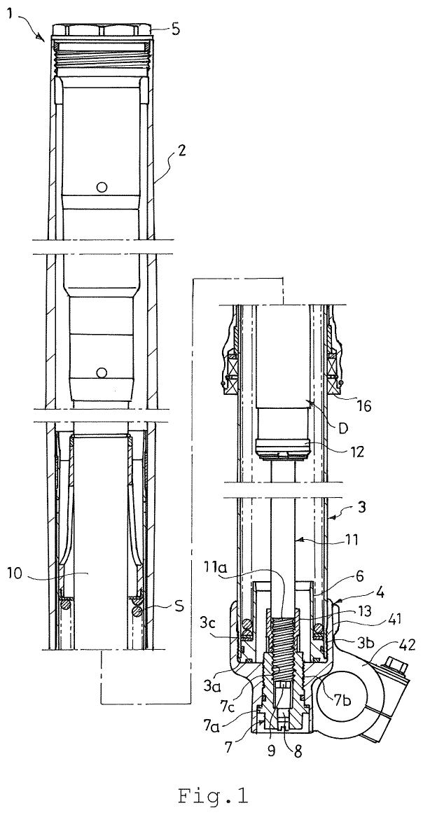

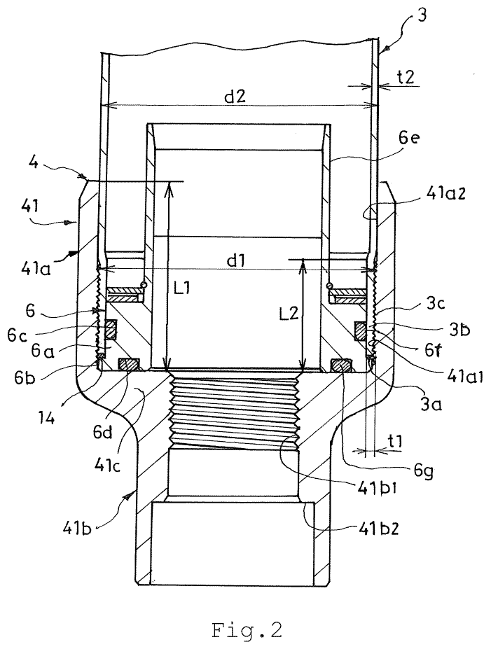

Hereinafter, the present invention will be described based on an embodiment illustrated in the drawings. As illustrated in FIGS. 1 and 2, a front fork 1 according to the present embodiment includes an upper tube 2, a lower tube 3 that is relatively movable in an axial direction with respect to the upper tube 2, and an axle bracket 4 screwed to an outer periphery of a lower end portion of the lower tube 3. In the front fork 1, the upper tube 2 is connected to a vehicle body of a straddle vehicle (not illustrated), and the lower tube 3 is connected to an axle (not illustrated) to which a front wheel of the straddle vehicle is rotatably attached via the axle bracket 4, and the front fork 1 is used by being interposed between the vehicle body and the front wheel of the straddle vehicle.

The front fork 1 according to the present embodiment is formed in a telescopic shape in which the lower tube 3 disposed on a lower side of the straddle vehicle is inserted into the upper tube 2 disposed on an upper side of the straddle vehicle so as to be movable in the axial direction, suspends the front wheel of the straddle vehicle (not illustrated), and expands and contracts along with the relative movement between the vehicle body and the front wheel (not illustrated). In addition, in the front fork 1 of the present embodiment, a damper cartridge D that is interposed between the upper tube 2 and the lower tube 3 and generates a damping force when the lower tube 3 relatively moves in the axial direction with respect to the upper tube 2 and a suspension spring S that is interposed between the upper tube 2 and the lower tube 3 and biases the upper tube 2 and the lower tube 3 to separate them are accommodated in a space formed by the upper tube 2 and the lower tube 3, and hydraulic oil (not illustrated) is stored outside the damper cartridge D in the space.

Hereinafter, individual portions in the front fork 1 will be described in detail. An upper end of the upper tube 2 is closed by a head cap 5. Moreover, on an inner periphery of a lower end of the upper tube 2, a seal 16 in slidably contact with an outer periphery of the lower tube 3 is provided to seal between the upper tube 2 and the lower tube 3. Since the space between the lower end portion of the lower tube 3 and the axle bracket 4 is sealed by a seal case 6 described later, the space formed by the upper tube 2 and the lower tube 3 is airtightly sealed. Note that in the front fork 1 of the present embodiment, the lower tube 3 is inserted into the upper tube 2, but conversely, the upper tube 2 may have a small diameter and be inserted into the lower tube 3.

Although not illustrated in detail, the damper cartridge D includes, for example, a cylinder 10 connected to the head cap 5 attached to the upper end of the upper tube 2, a piston rod 11 connected to the axle bracket 4 by a cylindrical screw member 7 and movably inserted into the cylinder 10, a piston (not illustrated) inserted into the cylinder 10 to be connected to the piston rod 11, and a damping valve (not illustrated), and the damper cartridge D exerts a damping force that hinders a relative movement between the upper tube 2 and the lower tube 3 in the axial direction at the time of expansion and contraction. Moreover, the damper cartridge D exchanges the hydraulic oil between the space formed by the upper tube 2 and the lower tube 3 and the inside of the cylinder 10 at the time of expansion and contraction, exerts a damping force, and performs the volume compensation of the piston rod 11 that enters and exits the cylinder 10. In the front fork 1 of the present embodiment, a control rod 9 inserted into the cylindrical piston rod 11 is moved up and down by the operation of an adjuster 8 attached to the inner periphery of the screw member 7, so that the damping force generated by the damper cartridge D can be adjusted by changing the flow path area in the damping valve (not illustrated).

The above-described configuration of the damper cartridge D is not limited to the structure described above, and the damper cartridge D may exert a damping force only by one of extension and contraction. Furthermore, although the cylinder 10 is connected to the upper tube 2 and the piston rod 11 is connected to the lower tube 3 respectively, the damper cartridge D may be installed upside down in the drawings.

In addition, in a case of being used as a front fork, the damper cartridge D may be omitted, and a force for resisting the approach of the lower tube 3 and the upper tube 2 may be exerted only by a biasing force of the suspension spring S. Moreover, although the suspension spring S is a coil spring in the drawings, the suspension spring S may be an air spring formed by enclosing a pressurized gas in the space.

Subsequently, a screw thread 3c is provided on the outer periphery of the lower end portion of the lower tube 3. As described above, the axle bracket 4 that holds the axle of the front wheel of the straddle vehicle (not illustrated) is attached, and an opening edge of the lower end 3a of the lower tube 3 is closed by the axle bracket 4.

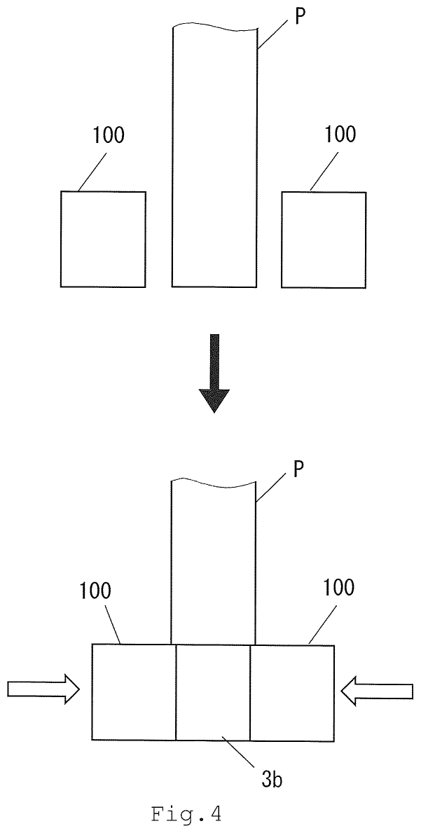

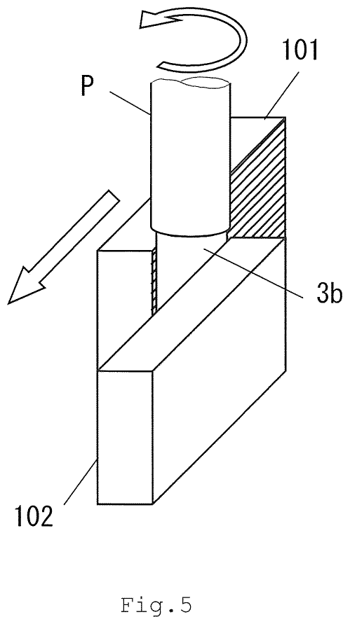

Specifically, as illustrated in FIG. 2, the lower tube 3 includes a diameter-reduced portion 3b of which the inner diameter is reduced from the upper side at the lower end portion, and the screw thread 3c provided on the outer periphery of the diameter-reduced portion 3b and to which the axle bracket 4 is screwed. The lower tube 3 is manufactured by performing the following processing. The lower tube 3 is manufactured using a pipe as a base material, and first, as illustrated in FIG. 4, the lower end portion of a pipe P as the base material is plastically deformed by swaging to caulk the lower end portion with a die 100 from the outer peripheral side, and the diameter-reduced portion 3b having an outer diameter smaller than that of the upper side and an inner diameter smaller than that of the upper side is formed at the lower end portion of the pipe (diameter reduction step). Subsequently, as illustrated in FIG. 5, the diameter-reduced portion 3b in the pipe P in which the diameter-reduced portion 3b is formed at the lower end portion is sandwiched between dies 101 and 102 on which a screw thread pattern is engraved, and one die 101 is moved in parallel with the other die 102 to roll to plastically deform the outer periphery of the diameter-reduced portion 3b into the shape of the screw thread, thereby forming the screw thread 3c on the outer periphery of the diameter-reduced portion 3b (screw thread forming step). The pipe is processed as described above to form the diameter-reduced portion 3b and the screw thread 3c at the lower end portion of the lower tube 3.

As described above, when the screw thread 3c is formed by rolling, unlike cutting, the screw thread 3c is formed by plastically deforming the diameter-reduced portion 3b.

Therefore, the screw thread 3c rises so as to protrude radially from the original outer periphery of the diameter-reduced portion 3b, and a thickness t1 from the outer periphery of the screw thread 3c to the inner periphery of the diameter-reduced portion 3b is thicker than a thickness t2 of a portion above the diameter-reduced portion 3b of the lower tube 3. In the front fork 1 of the present embodiment, an outer diameter d1 of the screw thread 3c is equal to or smaller than an outer diameter d2 of a portion above the diameter-reduced portion 3b in the lower tube 3.

As illustrated in FIG. 2, the axle bracket 4 includes a cylindrical portion 41 screwed to the outer periphery of the lower end portion of the lower tube 3, and an annular grip portion 42 provided on the side of the cylindrical portion 41 to grip the axle of the front wheel (not illustrated). The cylindrical portion 41 includes a large-diameter portion 41a including a screw portion 41al on the inner periphery and screwed to the outer periphery of the lower tube 3, a small-diameter portion 41b disposed below the large-diameter portion 41a and having inner and outer diameters smaller than those of the large-diameter portion 41a and including a screw portion 41b1 on the inner periphery, and an annular coupling portion 41c coupling a lower end of the large-diameter portion 41a and an upper end of the small-diameter portion 41b. In FIG. 2, in order to facilitate understanding of the invention, illustration of the damper cartridge D, the screw member 7, and the adjuster 8 attached to the small-diameter portion 41b of the cylindrical portion 41 of the axle bracket 4 is omitted.

As illustrated in FIG. 2, the large-diameter portion 41a includes the screw portion 41al from the lower end of the inner periphery to the vicinity of the center. In the small-diameter portion 41b, the inner diameter on the lower side is larger than the inner diameter on the upper side, and the small-diameter portion 41b includes a step portion 41b2 on the inner periphery and the screw portion 41b1 on the upper side of the inner periphery.

The screw member 7 having a cylindrical shape and including a flange 7a on the outer periphery is screwed to the inner periphery of the small-diameter portion 41b of the cylindrical portion 41 of the axle bracket 4. The screw member 7 has a cylindrical shape and includes an outer peripheral screw portion 7b provided above the flange 7a on the outer periphery and an inner peripheral screw portion 7c provided on the inner periphery. The screw member 7 is inserted into the small-diameter portion 41b of the cylindrical portion 41 of the axle bracket 4 until the flange 7a is restricted from entering the axle bracket 4 by the step portion 41b2, and the outer peripheral screw portion 7b is screwed to the screw portion 41b1 on the inner periphery of the small-diameter portion 41b and attached to the axle bracket 4.

A screw portion 11a formed on the outer periphery of the lower end of the piston rod 11 in the damper cartridge D is screwed to the inner peripheral screw portion 7c of the screw member 7 fixed to the inner periphery of the axle bracket 4 in this manner. Therefore, the piston rod 11 is connected to the axle bracket 4 via the screw member 7. A nut 13 whose lower end abuts the upper end of the screw member 7 is screwed to the screw portion 11a of the piston rod 11, and the piston rod 11 and the screw member 7 are prevented from loosening by tightening the nut 13.

The diameter-reduced portion 3b of the lower tube 3 formed as described above is inserted into the large-diameter portion 41a of the cylindrical portion 41 of the axle bracket 4, and the screw thread 3c is screwed to the screw portion 41al to connect the lower tube 3. Prior to the connection between the axle bracket 4 and the lower tube 3, the seal case 6 is inserted into the large-diameter portion 41a of the cylindrical portion 41.

The seal case 6 includes an annular case body 6a having a flange 6b at the lower end, an annular groove 6c formed along the circumferential direction on the outer periphery of the case body 6a, an annular groove 6d formed along the circumferential direction on the lower end of the case body 6a, a cylindrical oil lock case 6e rising from the inner periphery of the upper end of the case body 6a, and seal rings 6f and 6g accommodated in the annular grooves 6c and 6d, respectively. The inner diameter of the seal case 6 is larger than the outer diameters of the screw member 7 and the nut 13, and the case body 6a of the seal case 6 can be fitted into the diameter-reduced portion 3b of the lower tube 3. The outer diameter of the flange 6b of the seal case 6 is set to be larger than the inner diameter of the diameter-reduced portion 3b of the lower tube 3 and to be fittable into the large-diameter portion 41a.

The seal case 6 configured as described above is inserted into the large-diameter portion 41a of the axle bracket 4 and placed on the coupling portion 41c, and when the screw thread 3c of the lower tube 3 is screwed into the screw portion 41al on the inner periphery of the large-diameter portion 41a, the flange 6b is sandwiched between the lower end 3a of the lower tube 3 and the coupling portion 41c, so that the lower tube 3 is connected to the axle bracket 4 and the seal case 6 is fixed. A washer 14 is interposed between the flange 6b and the lower end 3a of the lower tube 3 to prevent the flange 6b from being deformed by the axial force received from the lower tube 3.

Further, an axial length L1 of the inner periphery of the large-diameter portion 41a of the axle bracket 4 is longer than a length L2 obtained by adding axial lengths of the flange 6b and the washer 14 and an axial length of the diameter-reduced portion 3b of the lower tube 3. When the lower tube 3 is screwed to the large-diameter portion 41a of the axle bracket 4, the upper end of the large-diameter portion 41a in FIG. 2 is disposed above the diameter-reduced portion 3b of the lower tube 3, and a non-screw portion 41a2, which is the inner periphery of the large-diameter portion 41a and on which no screw thread is formed above the screw portion 41al, covers and is in contact with a portion above the diameter-reduced portion 3b of the lower tube 3.

The oil lock case 6e in the seal case 6 allows an oil lock piece 12 provided at the lower end of the cylinder 10 of the damper cartridge D to enter the inside at the time of maximum contraction of the front fork 1. When the oil lock piece 12 enters the oil lock case 6e, the inside of the oil lock case 6e is closed by the oil lock piece 12, the pressure in the oil lock case 6e increases, and further shrinkage of the front fork 1 is suppressed.

As described above, the front fork 1 includes the upper tube 2, the lower tube 3 that is relatively movable in the axial direction with respect to the upper tube 2, and the axle bracket 4 that is screwed to the outer periphery of the lower end portion of the lower tube 3, and the lower tube 3 includes the screw thread 3c that is formed on the outer periphery of the diameter-reduced portion 3b that is reduced in diameter by plastic deformation by rolling at the lower end portion of the lower tube 3 and the axle bracket 4 is screwed to the screw thread 3c.

According to the front fork 1 configured as described above, the thickness of the diameter-reduced portion 3b in which the screw thread 3c of the lower tube 3 is reduced in diameter by plastic deformation is substantially the same as the thickness of the portion above the diameter-reduced portion 3b of the lower tube 3, and the screw thread 3c is formed by plastic deformation in which the screw thread 3c rises from the diameter-reduced portion 3b by rolling. Therefore, the thickness from the outer periphery of the screw thread 3c to the inner periphery of the diameter-reduced portion 3b can be made thicker as compared with the case where the screw thread is formed by cutting in which the thickness decreases, and the strength of the screw thread 3c portion can be secured.

Therefore, according to the front fork 1 of the present embodiment, even when the thickness of the lower tube 3 is made thin, the strength of the screw thread 3c portion can be secured and the weight reduction of the lower tube 3 can be achieved, so that weight reduction can be achieved while securing the strength.

In addition, the front fork 1 of the present embodiment includes the upper tube 2, the lower tube 3 that is relatively movable in the axial direction with respect to the upper tube 2, and the axle bracket 4 that is screwed to the outer periphery of the lower end portion of the lower tube 3. The lower tube 3 includes the diameter-reduced portion 3b of which the inner diameter is reduced from the upper side at the lower end portion, and the screw thread 3c that is provided on the outer periphery of the diameter-reduced portion 3b and to which the axle bracket 4 is screwed. The radial thickness t1 from the inner periphery of the diameter-reduced portion 3b to the outer periphery of the screw thread 3c is thicker than the radial thickness t2 of the portion above the diameter-reduced portion 3b of the lower tube 3. According to the front fork 1 configured as described above, the thickness of the upper side of the lower tube 3 can be made thin while securing the thickness of the screw thread 3c portion and the weight reduction of the lower tube 3 can be achieved, so that weight reduction can be achieved while securing the strength.

The method for manufacturing the front fork 1 according to the present embodiment is a method for manufacturing the front fork 1 including the upper tube 2, the lower tube 3 that is relatively movable in the axial direction with respect to the upper tube 2, and the axle bracket 4 screwed to the outer periphery of the lower end portion of the lower tube 3. The method includes a diameter reduction step of reducing the diameter of the lower end portion of the lower tube 3 by plastic deformation to form the diameter-reduced portion 3b, and a screw forming step of forming the screw thread 3c on the outer periphery of the diameter-reduced portion 3b by rolling. According to the method for manufacturing the front fork 1 configured as described above, the thickness of the diameter-reduced portion 3b in which the screw thread 3c of the lower tube 3 is reduced in diameter by plastic deformation is substantially the same as the thickness of the portion above the diameter-reduced portion 3b of the lower tube 3, and the screw thread 3c is formed by plastic deformation in which the screw thread 3c rises from the diameter-reduced portion 3b by rolling. Therefore, the thickness from the outer periphery of the screw thread 3c to the inner periphery of the diameter-reduced portion 3b can be made thicker as compared with the case where the screw thread is formed by cutting in which the thickness decreases, and the strength of the screw thread 3c portion can be secured.

Therefore, according to the method for manufacturing the front fork 1 of the present embodiment, even when the thickness of the lower tube 3 is made thin, the strength of the screw thread 3c portion can be secured and the weight reduction of the lower tube 3 can be achieved, so that weight reduction can be achieved while securing the strength.

In addition, in the front fork 1 of the present embodiment, since the outer diameter of the screw thread 3c in the lower tube 3 is equal to or smaller than the outer diameter of the portion above the diameter-reduced portion 3b in the lower tube 3, there is no concern of polishing the screw thread 3c when buffing the outer periphery of the lower tube 3, and buffing work is facilitated.

Further, in the front fork 1 of the present embodiment, the axle bracket 4 has the cylindrical portion 41 into which the lower end portion of the lower tube 3 is inserted, and the cylindrical portion 41 covers a portion from the lower end 3a of the lower tube 3 to a position exceeding the diameter-reduced portion 3b. According to the front fork 1 configured as described above, the portion where the shape of the boundary between the diameter-reduced portion 3b of the lower tube 3 and the portion above the diameter-reduced portion 3b changes is covered by the cylindrical portion 41 of the axle bracket 4, and even when a bending moment acts on the lower tube 3, it is possible to avoid stress concentration on the portion by the cylindrical portion 41 of the axle bracket 4, so that it is possible to achieve further thickness reduction of the lower tube 3, resulting in further weight reduction.

In the front fork 1 of the present embodiment, the radial thickness t1 from the inner periphery of the diameter-reduced portion 3b to the outer periphery of the screw thread 3c is thicker than the radial thickness t2 of the portion above the diameter-reduced portion 3b of the lower tube 3. According to the front fork 1 configured as described above, the thickness of the upper side of the lower tube 3 can be made thin while securing the thickness of the screw thread 3c portion and the weight reduction of the lower tube 3 can be achieved, so that weight reduction can be achieved while securing the strength.

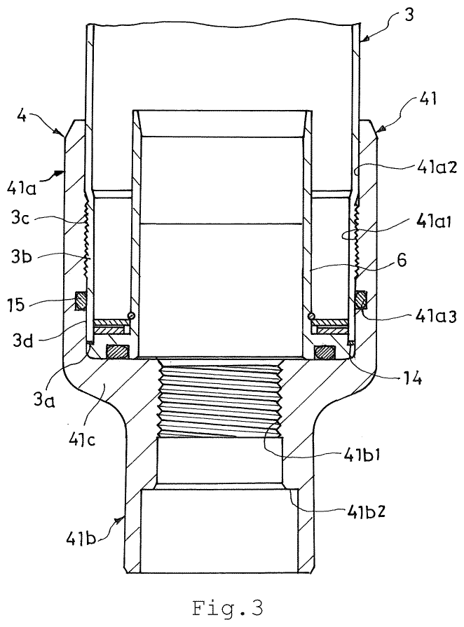

Furthermore, the front fork 1 of the present embodiment includes the seal case 6 that is sandwiched between the lower end 3a of the lower tube 3 and the axle bracket 4, fitted to the inner periphery of the diameter-reduced portion 3b, and fixed to the axle bracket 4, and the seal ring 6f that is provided on the outer periphery of the seal case 6 and is in close contact with the inner periphery of the diameter-reduced portion 3b of the lower tube 3. According to the front fork 1 configured as described above, since the seal ring 6f can be provided on the inner periphery of the diameter-reduced portion 3b to seal between the axle bracket 4 and the lower tube 3, the axial length of the large-diameter portion 41a of the axle bracket 4 covering the lower portion of the lower tube 3 can be shortened, which is advantageous in terms of weight reduction. However, as illustrated in FIG. 3, in this case, although the axial length of the diameter-reduced portion 3b increases and the axial length of the large-diameter portion 41a of the axle bracket 4 increases, the axial length of the diameter-reduced portion 3b may be made longer than the axial length of the screw thread 3c, the non-screw portion 3d in which no screw thread is formed may be provided below the screw thread 3c of the diameter-reduced portion 3b, the annular groove 41a3 for accommodating the seal ring 15 may be provided on the inner periphery of the large-diameter portion 41a of the axle bracket 4, and the seal ring 15 may be brought into close contact with the non-screw portion 3d to seal between the lower tube 3 and the axle bracket 4. In FIG. 3, similarly to FIG. 2, illustration of the damper cartridge D, the screw member 7, and the adjuster 8 attached to the small-diameter portion 41b of the cylindrical portion 41 of the axle bracket 4 is omitted.

Although the preferred embodiment of the present invention has been described above in detail, modifications, variations, and changes can be made thereto without departing from the claims.

What is claimed is:

1. A front fork comprising:
an upper tube;
a lower tube that is relatively movable in an axial direction with respect to the upper tube; and
an axle bracket screwed to an outer periphery of a lower end portion of the lower tube,
wherein the lower tube has a screw thread formed on an outer periphery of a diameter-reduced portion that is reduced in diameter by plastic deformation by rolling at the lower end portion of the lower tube, and the axle bracket is screwed to the screw thread.

2. The front fork according to claim 1, wherein an outer diameter of the screw thread in the lower tube is equal to or smaller than an outer diameter of a portion above the diameter-reduced portion in the lower tube.

3. The front fork according to claim 2, wherein
the axle bracket has a cylindrical portion into which the lower end portion of the lower tube is inserted, and
the cylindrical portion covers from a lower end of the lower tube to a position exceeding the diameter-reduced portion.

4. The front fork according to claim 1, wherein a radial thickness from an inner periphery of the diameter-reduced portion to an outer periphery of the screw thread is thicker than a radial thickness of a portion above the diameter-reduced portion of the lower tube.

5. The front fork according to claim 1, further comprising:
a seal case sandwiched between a lower end of the lower tube and the axle bracket, fitted to an inner periphery of the diameter-reduced portion, and fixed to the axle bracket; and
a seal ring provided on an outer periphery of the seal case and brought into close contact with the inner periphery of the diameter-reduced portion of the lower tube.

6. A front fork comprising:
an upper tube;
a lower tube that is relatively movable in an axial direction with respect to the upper tube; and
an axle bracket screwed to an outer periphery of a lower end portion of the lower tube,
wherein the lower tube has
a diameter-reduced portion of which an inner diameter is reduced from an upper side at a lower end portion, and
a screw thread provided on an outer periphery of the diameter-reduced portion and to which the axle bracket is screwed, and
a radial thickness from an inner periphery of the diameter-reduced portion to an outer periphery of the screw thread is thicker than a radial thickness of a portion above the diameter-reduced portion of the lower tube.

7. A method for manufacturing a front fork including:
an upper tube;
a lower tube that is relatively movable in an axial direction with respect to the upper tube; and
an axle bracket screwed to an outer periphery of a lower end portion of the lower tube,
the method comprising:
a diameter reduction step of reducing a diameter of the lower end portion of the lower tube by plastic deformation to form a diameter-reduced portion; and
a screw forming step of forming a screw thread on an outer periphery of the diameter-reduced portion by rolling.
